(19) United States
(12) Patent Application Publication
(10) Pub. No.: US 2025/0020847 A1
(43) Pub. Date: Jan. 16, 2025

(54) METASURFACE WAVEGUIDE COUPLER FOR DISPLAY UNIT

(71) Applicant: CORNING INCORPORATED, CORNING, NY (US)

(72) Inventors: Sukru Ekin Kocabas, Santa Clara, CA (US); Cameron Robert Nelson, Elmira, NY (US); Jun Yang, Los Gatos, CA (US); Alexander Yutong Zhu, Santa Clara, CA (US)

(21) Appl. No.: 18/707,943

(22) PCT Filed: Oct. 31, 2022
(86) PCT No.: PCT/US2022/048404

§ 371 Date: May 7, 2024

Related U.S. Application Data
(60) Provisional application No. 63/277,201, filed on Nov. 9, 2021.

(51) Int. Cl. F21V 8/00; G02B 27/01

(52) U.S. Cl. CPC G02B 6/0016; G02B 6/0038; G02B 6/0065; G02B 27/0172

(57) ABSTRACT

The disclosure relates to a grating coupler, the grating coupler comprising: a substrate comprising a first major surface and a second major surface; and a surface relief structure located on at least one of the major surfaces of the substrate wherein: the grating coupler has a first order diffraction efficiency of at least 0.3 (30%) across at least a 20° incident light angle range. The surface relief structures described herein can comprise a plurality of notches, each of the notches facing substantially in a x-direction and having a radius of curvature greater than about 50 nm.

### CROSS-REFERENCE TO RELATED APPLICATIONS

This application claims the benefit of priority under 35 U.S.C. § 119 of U.S. Provisional Application No. 63/277,201 filed Nov. 9, 2021, the content of which is incorporated herein by reference in its entirety.

### BACKGROUND

Display units, for example display units used in augmented reality (AR) or virtual reality (VR) devices, may refract light of specified wavelength(s). Techniques for designing and fabricating surfaces that optimally refract such light can be desirable.

### SUMMARY

The disclosure relates to a grating coupler, the grating coupler comprising: a substrate comprising a first major surface and a second major surface; and a surface relief structure located on at least one of the major surfaces of the substrate wherein: the grating coupler has a first order diffraction efficiency of at least 0.3 (30%) across at least a 20° incident light angle range.

The disclosure also relates to a grating coupler, the grating coupler comprising: a substrate comprising a first major surface and a second major surface; a surface relief structure located on at least one of the major surfaces of the substrate the surface relief structure having a periodicity in an x-direction of about 0.2 to about 1 μm and a periodicity in ay-direction of about 0.2 μm to about 1 μm; wherein: the surface relief structure comprises a plurality of notches, each of the notches facing substantially in a x-direction and having a radius of curvature of greater than about 50 nm.

### DESCRIPTION OF THE DRAWINGS

The drawings illustrate generally, by way of example, but not by way of limitation, various embodiments discussed herein.

FIG. 1A illustrates a representative example of a waveguide combiner architecture, in accordance with the disclosure.

FIG. 1B illustrates an example single waveguide architecture carrying three colors, (red, green, and blue) in accordance with the disclosure.

FIGS. 2A-2B illustrate an example metasurface input coupler element, in accordance with the disclosure.

FIG. 3A illustrates a first example waveguide coupler, in accordance with the disclosure.

FIG. 3B illustrates an example graph relating transmission in first order to the incident angle for the first example waveguide coupler of FIG. 3A, in accordance with the disclosure.

FIG. 3C illustrates a second example waveguide coupler/metagrating design, in accordance with the disclosure.

FIG. 3D illustrates an example graph relating transmission in first order to the incident angle for the second example waveguide coupler/metagrating design of FIG. 3C, in accordance with the disclosure.

FIG. 3E is a top view of a surface relief structure 208 shown in FIG. 3C.

FIG. 4A illustrates an example metagrating design, in accordance with the disclosure.

FIG. 4B illustrates angle dependent coupling efficiency for the metagrating design of FIG. 4A, in accordance with the disclosure.

FIG. 5A illustrates the relationship between the incident angle and the diffracted angle, in accordance with the disclosure.

FIG. 5B illustrates the incident angle as a function of normalized grating spatial frequency, in accordance with the disclosure.

FIG. 5C illustrates an incident angle that impacts a substrate from the side, as opposed to from above, as shown in FIG. 5A. And even though the substrates shown in FIGS. 5A and 5C are shown as being flat, curved substrates are also contemplated herein.

FIG. 6 illustrates an e-beam and atomic layer deposition process for nanofabrication of titania nanostructures, in accordance with some embodiments.

FIG. 7 illustrates an example procedure 1000 for nanoimprint lithography, in accordance with some embodiments.

FIG. 8A illustrates a top-down view of the structure, in accordance with some embodiments.

FIG. 8B illustrates example scanning electron microscope image of fabricated TiO₂ inverse design grating, in accordance with some embodiments.

FIG. 8C illustrates example measured first-order transmittance of the grating device, in accordance with some embodiments.

FIG. 8D illustrates example simulated transmittance of the grating device, in accordance with some embodiments.

FIGS. 9A-9B illustrate example glass configurations in which some embodiments may be implemented, in accordance with some embodiments.

Unless otherwise indicated, all figures and drawings in this document are not to scale and are chosen for the purpose of illustrating different embodiments of the invention. The dimensions of the various components are depicted in illustrative terms only, and no relationship between the dimensions of the various components should be inferred from the drawings, unless so indicated. Although terms such as “top”, “bottom”, “upper”, “lower”, “under”, “over”, “front”, “back”, “up” and “down”, and “first” and “second” can be used in this disclosure, it should be understood that those terms are used in their relative sense only unless otherwise noted.

### DESCRIPTION

The following description and the drawings sufficiently illustrate specific embodiments to enable those skilled in the art to practice them. Other embodiments may incorporate structural, logical, electrical, process, and other changes. Portions and features of some embodiments can be included in, or substituted for, those of other embodiments. Embodiments set forth in the claims encompass all available equivalents of those claims.

Augmented reality (AR), sometimes known as mixed reality (MR or XR), is a concept that has been steadily gaining prominence. While it has its roots in the defense industry, in the form of various head-mounted displays for flight simulators and related training programs, AR may lead to the next evolution of the traditional display technology, which has gone from cathode ray tube television sets to liquid crystal display (LCD) computer monitors/laptop screens, to organic light emitting diode (OLED) tablets and smartphones. The AR market is projected to grow.

Unlike some use cases of virtual reality (VR), AR can be demanding in terms of the optical technologies involved, since light from both the ambient environment as well as from a micro-display can be conveyed accurately to the viewer with reasonable efficiency. This may leverage the presence of a light combiner, which typically takes the form of either a freeform optic such as a beam splitter/combiner or waveguide coupler. The former approach might, in some cases, place high demands on optics involved, which might simultaneously magnify and increase the optical path length from the display to the eye, correct for optical aberrations, and allow light from the real world to pass through without distortion or interference. This can require sophisticated optics such as freeform prisms, which might be bulky and have a large spatial footprint. For that reason, waveguide architectures are attractive because of their inherently compact form factor, and their ability to provide eyebox expansion without the need for additional, bulky optics. A pair of grating in/out-couplers couples the light from the display into/out of a waveguide. The optical path length can be increased via total internal reflection (TIR), and any distortion introduced by the input grating can be reversed by the output grating coupler. The latter can be usually identical to the former except for a gradient in efficiency, which allows for eyebox expansion. Thus, waveguide architectures have emerged as the forerunner.

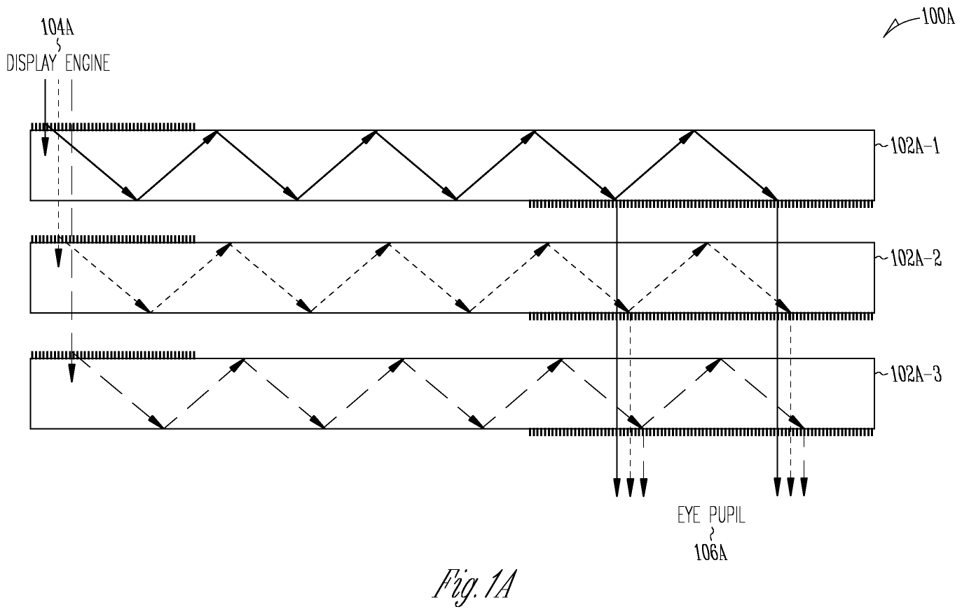

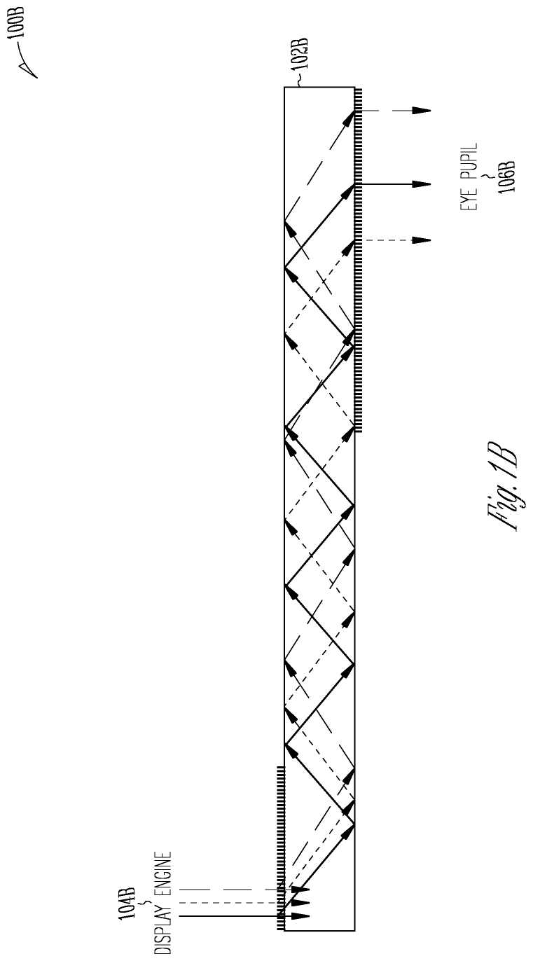

A representative example of a waveguide combiner architecture 100A is shown in FIG. 1A. The overall AR device includes three separate waveguides, each with a pair of incoupling/outcoupling gratings 102A-1, 102A-2, 102A-3. As shown, the grating 102A-1 is for blue light. The grating 102A-2 is for green light. The grating 102A-3 is for red light. Each primary color-blue, green, and red—is associated with a different wavelength of light. This is done to couple in light over the maximum range of incident angles allowed by the waveguide, thereby increasing the field of view (FOV) for a given substrate index and grating periodicity. As shown, the grating receive light from a display engine 104A (or other visual data) and defract the light from the display engine 104A onto the eye pupil 106A. In FIG. 1A, the gratings shown are slanted gratings, but any periodic diffractive optical element can be used. The judicious design of these optical elements is useful in realizing high efficiency, a large eyebox, and large FOV simultaneously.

FIG. 1A illustrates an example red-green-blue (RGB) three waveguide architecture 100A, in accordance with the disclosure. As shown in FIG. 1A, a display engine 104A generates red, green, and blue light (with each color being associated with a different wavelength). The blue light is processed via waveguide 102A-1. The green light is processed via waveguide 102A-2. The red light is processed via waveguide 102A-3. The output of the waveguides 102A-1, 102A-2, and 102A-3 is provided to an eye pupil 106A.

FIG. 1B illustrates an example single waveguide architecture 100B carrying three colors, (red, green, and blue) in accordance with the disclosure. As shown, a display engine 104B generates red, green, and blue light. All the light (red, green, and blue) is processed via a single waveguide 102B to generate output that is provided to an eye pupil 102B. Advantageously, the single waveguide architecture 100B requires fewer waveguides than the three-waveguide architecture 100A.

One limitation of existing grating couplers for waveguide AR architectures is the aforementioned field of view (FOV). This can include, according to some examples, the range of incidence angles of lights that can be coupled into a planar waveguide. This can correspond to the range of angles over which a viewer can see the AR display. In traditional gratings, the FOV is determined by the geometrical parameters of the grating structure (e.g., periodicity, index contrast, slant angle) in accordance with Bragg's Law. However, this FOV can be about 30-40 degrees, compared to the FOV of the human eye which is almost 180 degrees. Additionally, the coupling efficiency as a function of incident angle is also a concern. Ideally, grating couplers may possess an efficiency that is uniform across the FOV, which best approximates the natural viewing condition. However, in practice in addition to having a limited FOV, the efficiency of typical gratings falls off sharply with increasing FOV and can lead to imaging artifacts and an unpleasant viewing experience. As a result of this sharp fall-off, the effective FOV of the system might be significantly reduced. The design of these periodic elements can be useful to realizing high efficiency, a large eyebox, and large FOV simultaneously.

The disclosure therefore relates to a unique design of subwavelength gratings with freeform (topology-optimized) shapes. These have a significantly larger FOV than most alternative competing technologies, are inherently more versatile as they can be designed to accommodate multiple different specifications and performance metrics and possess a nearly uniform efficiency over the FOV.

Described herein are meta-grating couplers to replace existing surface relief grating. The grating couplers described herein help create gratings having broad field of view as the design objective, effectively equalizing the scattering efficiency at different incident angle, and achieving a balanced efficiency over a wide field of view. The gratings couplers described herein are not limited to simple lateral geometries, and thus have a significantly larger design space compared with traditional grating designs, and thus are able to find higher performance. The grating designs described herein use a single thin layer of material with binary surface heights (no slants or grayscale feature height variation) and are therefore relatively easier to fabricate and manufacture compared to some existing surface relief grating designs.

The disclosure provides an inverse-designed, diffraction efficiency optimized metasurface grating input coupler operating in the visible wavelengths. The design methodology for the grating elements can be applied towards high performance AR/VR waveguide couplers. The grating unit cells (tiled horizontally and vertically) may include nanoscale, dielectric structures with free-form lateral geometries and a single height level fabricated on a glass substrate. The lateral nanostructure geometries are topologically optimized to achieve the highest (or higher than a threshold) diffraction efficiency uniformity and FOV for a selected wavelength.

The output grating coupler of the AR system may leverage a gradient in transmission efficiency to ensure the highest eyebox expansion. The gradient can be achieved by, for example, a variation in the grating height (depth). In some embodiments, the same effect may also be achieved by selecting different target transmittance values for the optimized metagrating unit cells, then stitching together the unit cells with varying transmittance values.

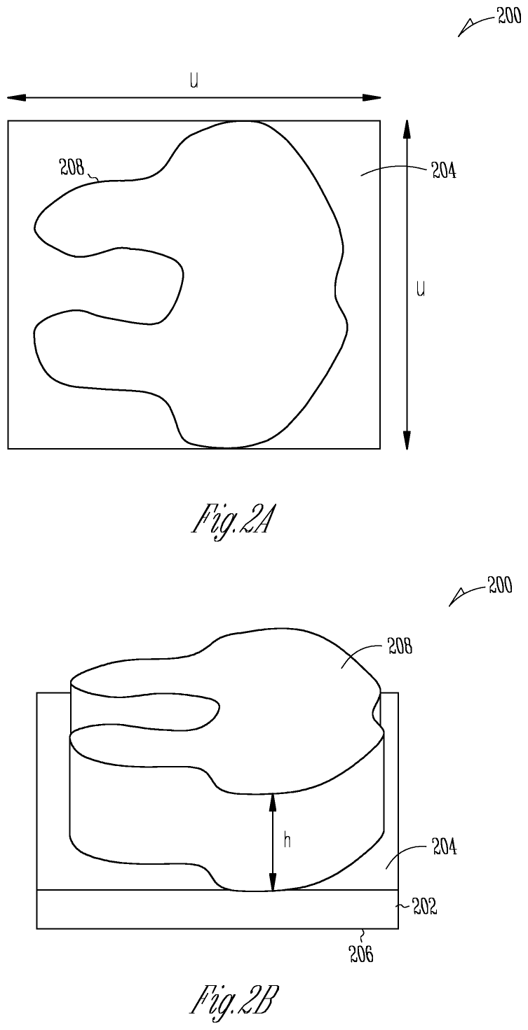

Making reference to FIGS. 2A-2B, the disclosure relates to a portion of a grating coupler 200, the grating coupler comprising a substrate 202 comprising a first major surface 204 and a second major surface 206; and a surface relief structure 208 located on at least one of the major surfaces of the substrate wherein: the grating coupler 200 has a first order diffraction efficiency of at least 0.3 (30%) (for example, at least about 0.3, at least about 0.35, at least about 0.40, at least about 0.45, at least about 0.5, at least about 0.6, from about 0.3 to about 0.6, about 0.3 to about 0.45, about 0.35 to about 0.6, or about 0.4 to about 0.5) across at least a 20° incident light angle range (for example, at least about 25°, at least about 30°, at least about 35°, at least about 40°, at least about 45°, at least about 50°, at least about 55°, at least about 60°, from about 20° to about 90°, about 20° to about 60°, about 20° to about 45°, about 30° to about 60° or about 30° to about) 60°. Thus, for example, the grating couplers described herein can have a first order diffraction efficiency of at least 0.3 (30%) across at least a 40° incident light angle range. Alternatively, or in addition, the grating couplers described herein can have a first order diffraction efficiency that does not change by more than 20% from a peak efficiency over at least a 30° incident light angle range.

The substrate can be chosen to be n=1.8 index glass, which can be used AR applications, although a higher refractive index substrate can also be chosen. It should be noted that the FOV of the grating coupler improves with increasing substrate refractive index. The grating unit cell dimension (u in FIGS. 2A-2B) is chosen to be λ/1.1 (for example, the grating unit cell dimension can be chosen to be λ/2.0 to λ/1.0 or λ/1.2 to λ/1.05), where A is the design wavelength. The height dimension h can be optimized around 200-300 nm. In some examples, the height dimension h can be between 100 and 1000 nm. Thus, for example, the surface relief structure 208 can have an average height in a z-direction of about 0.15 μm (150 nm) to about 0.25 μm (250 nm), about 0.1 μm (100 nm) to about 0.5 μm (500 nm) or about 0.15 μm (150 nm) to about 0.35 μm (350 nm).

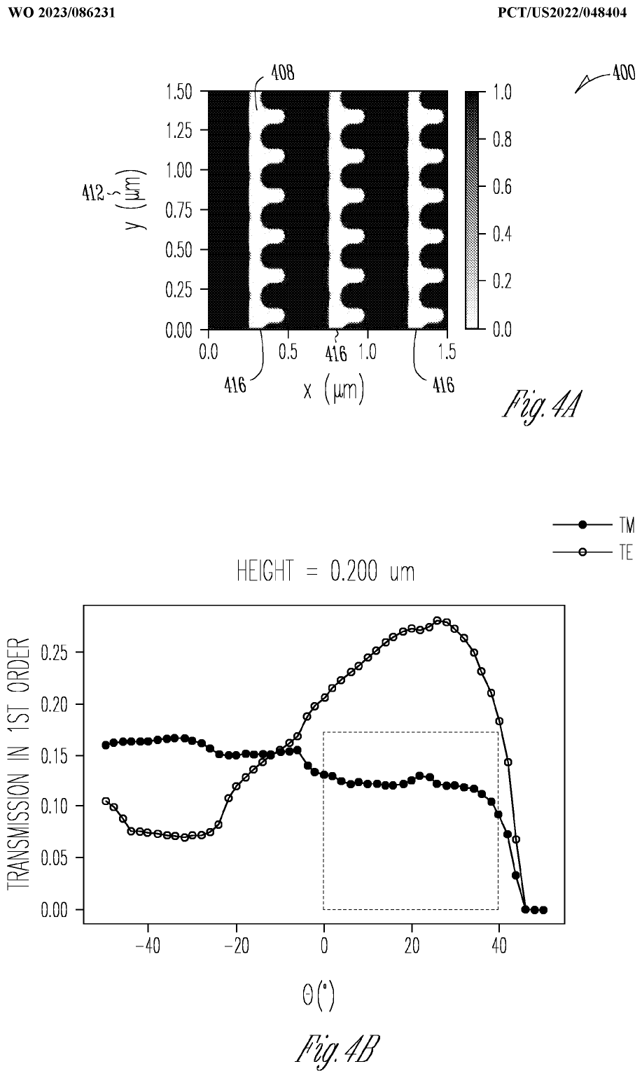

The surface relief structures described herein (for example surface relief structure 208 and 408, the latter described in FIG. 4A) can also have a refractive index, such as at least 1.9, at least 2.0, at least 2.1, at least 2.2 or from about 1.9 to about 2.5. The refractive index of the surface relief structures described herein can be chosen such that the grating coupler has a ratio of first order diffraction efficiency to a refractive index of the surface relief structure of about 0.05 to about 0.15 (for example about 0.05 to about 0.1, about 0.1 to about 0.15, about 0.05 to about 0.09, about 0.075 to about 0.15 or about 0.09 to about 0.13).

Choosing a dielectric grating material with a high refractive index relative to air can be useful for inverse design because it allows for the existence of optical resonant modes within the thin dielectric layer that can constructively interfere in the intended diffraction direction. In some cases, a lower limit for the grating material refractive index can be n=2.0.

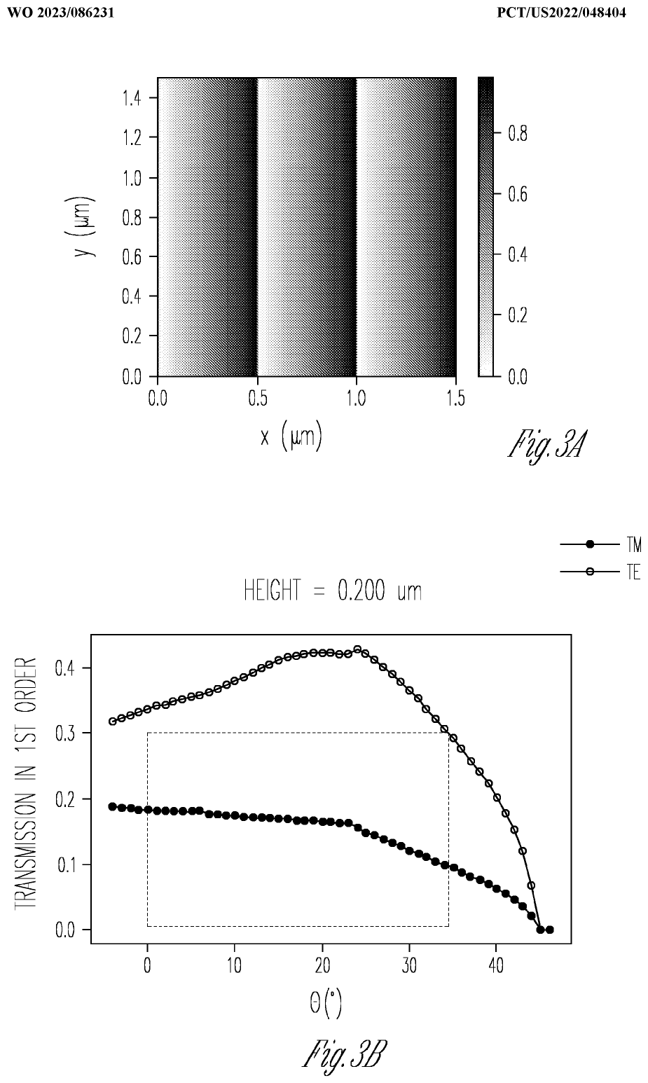

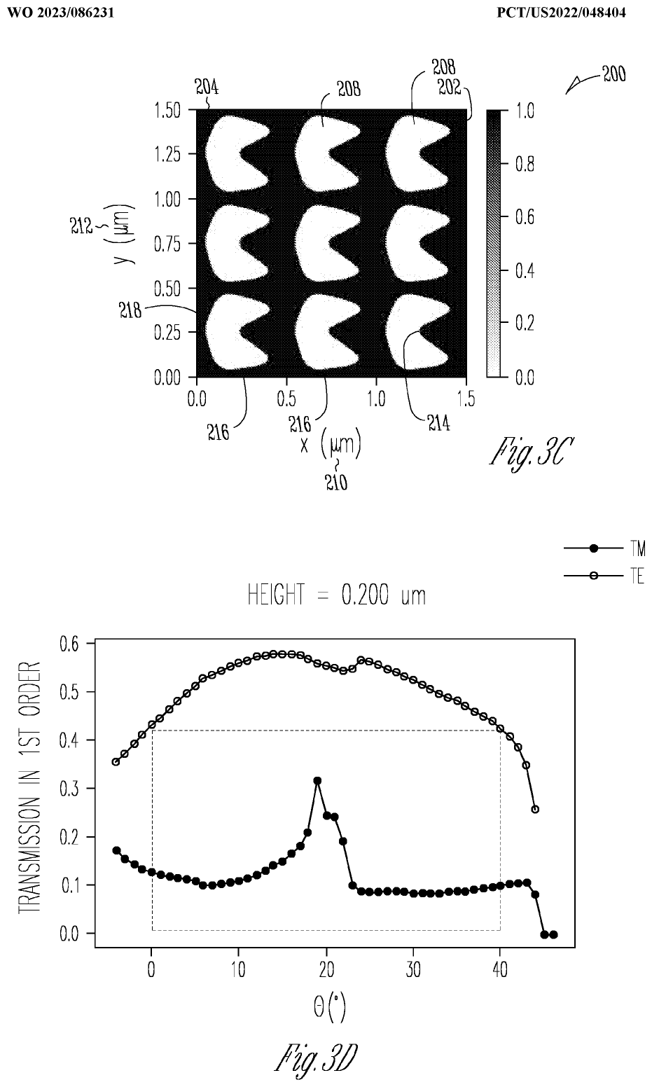

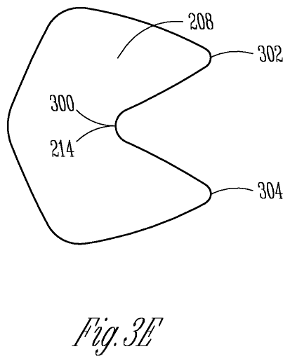

FIG. 3A illustrates an example of a graded index grating coupler, wherein 1.0 indicated a high index material and 0,0 indicates a low index material. FIG. 3B illustrates an example graph relating transmission in first order, which term is used interchangeable herein with “first order diffraction efficiency,” to the incident angle for the first example waveguide coupler of FIG. 3A. FIG. 3C illustrates a second example grating coupler 200 comprising a substrate 202 comprising a first major surface 204 and a second major surface 206 (not shown); and a surface relief structure 208 located on at least one of the major surfaces of the substrate. FIG. 3D illustrates an example graph relating transmission in first order to the incident angle for the second example waveguide coupler of FIG. 3C. A plurality of surface relief structures 208 is shown in FIG. 3C. The periodicity of the plurality of surface relief structures can be any suitable periodicity in the x- and y-direction, as shown in FIG. 3C. For example, the periodicity of the plurality of surface relief structures in the x-direction 210 and the periodicity in the y-direction 212 is from about 0.4 μm to about 0.7 μm.

TiO₂ is one choice for dielectric metasurfaces operating in the visible wavelengths due to its relatively high refractive index (˜2.4 in the visible spectrum) and low material loss. FIGS. 3A-3D compare an unoptimized TiO₂ grating structure (linear blazed grating) to an optimized TiO₂ inverse design. The linear blazed grating (FIG. 3A) shows a relatively sharp maximum in transmission that decays rapidly away from 20 degrees (FIG. 3B). As a result of the rapid decay, the transmission falls below 30% for incident angles exceeding 34 degrees (FIG. 3B). On the other hand, the inverse-designed TiO₂ grating shown in FIG. 3C maintains a 40% transmission level up to 41 degrees angle of incidence (see FIG. 3D). The usable angular bandwidth of an incoupler system can be taken as the full width at half maximum (FWHM) of the incident-angle dependent transmittance. The improvement in diffraction efficiency uniformity afforded by the inverse design structure therefore results in a higher effective FOV.

FIGS. 3A-3D illustrate a comparison an unoptimized gradient index grating versus a topology optimized metasurface grating. In both cases, the highest index is TiO₂ (nₘₑₜₐ=2.39). λ=0.55 μm, hₘₑₜₐ=0.2 μm, n_{substrate}=1.80. In FIGS. 3A and 3C, the image of the grating lateral structure is shown. Black corresponds to TiO₂, white corresponds to air, and gray corresponds to an intermediate index. FIGS. 3B and 3D show the scattering efficiency in the first order in transmission for both TE and TM polarized light, with FIG. 3B corresponding to FIG. 3A, and FIG. 3D corresponding to FIG. 3C.

Making reference to FIG. 3C, the disclosure relates to a grating coupler 200, the grating coupler comprising: a substrate 202 comprising a first major surface 204 and a second major surface (not shown); a surface relief structure 208 located on at least one of the major surfaces of the substrate 202 the surface relief structure 208 having a periodicity in an x-direction 210 of about 0.2 to about 1 μm and a periodicity in a y-direction 212 of about 0.2 μm to about 1 μm; wherein: the surface relief structure 208 comprises a plurality of notches 214, each of the notches 214 facing substantially in a x-direction and having a plurality of radii of curvature 300, 302, and 304 of greater than about 50 nm (for example, from about 50 nm to about 100 nm, from about 50 nm to about 80 nm, such as about 70 nm or greater, such as, for example, an infinite radius of curvature (denoting a straight line), such as from about 50 nm to about infinite or from about 70 nm to about infinite). See FIG. 3E where the notch 214 has a radius of curvature 300 and there are two additional portions of the surface relief structure 208 having two additional radii of curvature

To promote manufacturing ease, some embodiments leverage designs in which a high (refractive) index polymer is used to form the surface relief structures described herein (for example surface relief structure 208 and 408, the latter described in FIG. 4A) in place of the pure TiO₂. In some instances, the effective refractive index of the polymer can be tuned by loading the polymer with TiO₂ nanoparticles. The final refractive index of the loaded resin depends on the density of the nanoparticles and can be calculated using the Maxwell-Garnet formula Nanoparticle loaded resins may have refractive indices reaching up to 1.9-2.0. Also contemplated herein are monolithic grating couplers wherein the surface relief structures described herein (for example surface relief structure 208 and 408, the latter described in FIG. 4A) are formed from the same material (for example, n=2.0 glass or similar glass substrate) as the substrate. For example, the surface relief structures described herein (for example surface relief structure 208 and 408, the latter described in FIG. 4A) can be formed by etching the substrate. In short, the surface relief structures described herein (for example surface relief structure 208 and 408, the latter described in FIG. 4A) can comprise an inorganic material (for example, TiO₂), an organic material (for example, a polymer, such as (poly)methylmethacrylate (PMMA) or an organic material comprising an inorganic material dispersed in the organic material (for example, a polymer such as PMMA incorporating TiO₂ nanoparticles, as described herein).

FIG. 4A illustrates an example metagrating design of a grating coupler 400 according to the disclosure. In this example, the grating coupler 400 has a surface relief structure 408 comprising a plurality of contiguous columns 416 arranged in the periodicity in the x-direction 410, the columns extending in the y-direction 412. The grating coupler 208 shown in FIG. 3C is an example wherein the surface relief structure 208 comprises a plurality of non-contiguous columns 216 and rows 218 arranged in the periodicity in the x-direction 210 and the y-direction 212. The grating couplers 200 and 400 can have a first order diffraction efficiency of at least 0.3 (30%) (for example, at least about 0.3, at least about 0.35, at least about 0.40, at least about 0.45, at least about 0.5, at least about 0.6, from about 0.3 to about 0.6, about 0.3 to about 0.45, about 0.35 to about 0.6, or about 0.4 to about 0.5) across at least a 20° incident light angle range (for example, at least about 25°, at least about 30°, at least about 35°, at least about 40°, at least about 45°, at least about 50°, at least about 55°, at least about 60°, from about 20° to about 90°, about 20° to about 60°, about 20° to about 45°, about 30° to about 60° or about 30° to about) 60°. Thus, for example, the grating couplers described herein can have a first order diffraction efficiency of at least 0.3 (30%) across at least a 40° incident light angle range. Alternatively, or in addition, the grating couplers described herein can have a first order diffraction efficiency that does not change by more than 20% from a peak efficiency over at least a 30° incident light angle range. Alternatively, or in addition, grating couplers 200 and 400 can comprises only two “levels” comprised of the substrate and the surface relief structure, without any intermediate “levels” such that a cross-section of grating couplers 200 and 400 where a surface relief structure is located would show only two layers, one corresponding to the surface relief structure 208/408 and the other corresponding to the substrate 204/404.

FIG. 4B illustrates angle dependent coupling efficiency for the metagrating design of FIG. 4A, with n_{substrate}=1.80, nₘₑₜₐ=2.0, hₘₑₜₐ=0.2 μm. Pure TiO₂ structures can be fabricated using nanoimprint lithography techniques, where a master pattern is used to stamp the inverse design pattern in resist, followed by an etching step to reveal the TiO₂ structures. In this case, the final grating design can be directly patterned using nanoimprint masters into the high index polymer without an etching step. The design assuming n=2.0 is shown in FIG. 4A with the performance shown in FIG. 4B.

It is also possible to realize high efficiency devices using other high index materials such as crystalline silicon, although the optical absorption of this material for visible wavelengths can be higher than TiO₂. The optical loss in amorphous silicon might be too high to consider it as a design material. However, it is typically difficult to create high quality thin layers of crystalline silicon on glass since it might, in some cases, leverage a bonding/transfer step.

The grating structure satisfies the grating equation, Equation 1.

$${n}_{1} * sin θ + \frac{m λ}{d} = {n}_{2} * sin α \qquad Equation 1$$

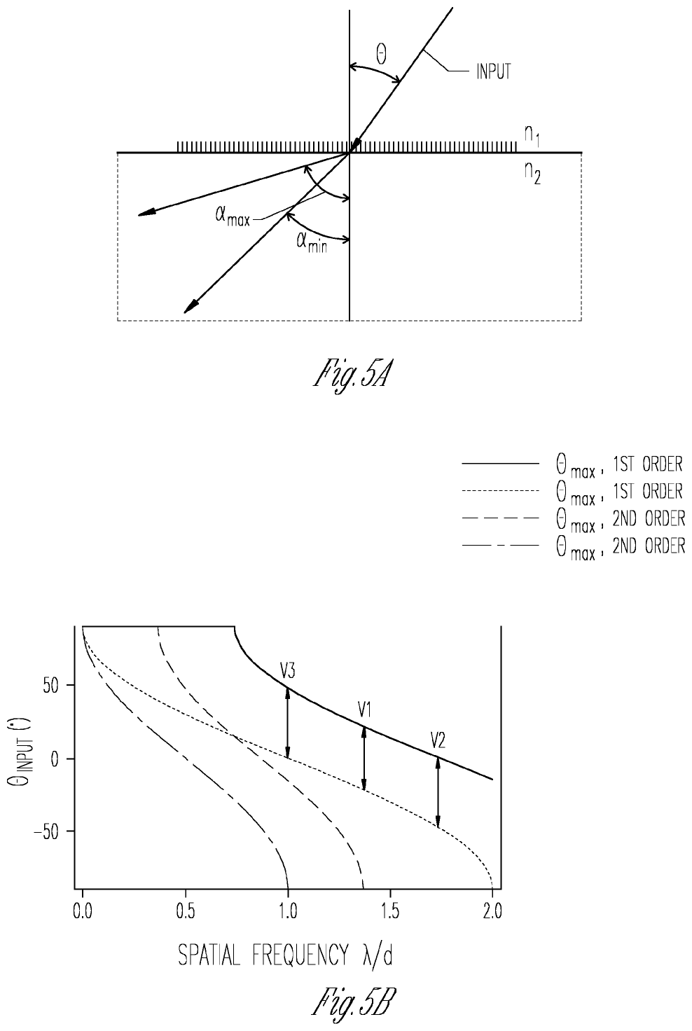

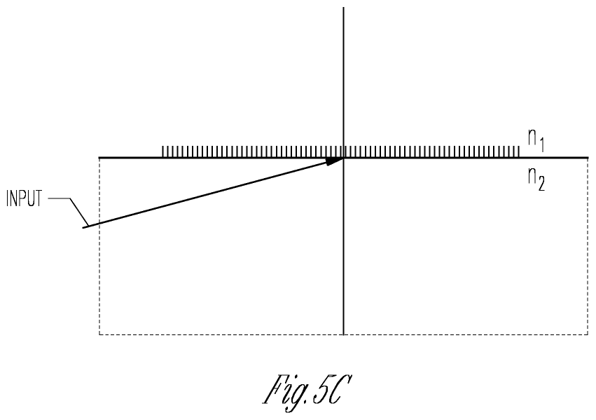

In Equation 1, n₁ and n₂ are the refractive index of the environment (air, n₁=1) and the substrate (high index glass, n₂=1.8), θ is the incident angle, a is the output angle, m is the grating order, λ is the wavelength, and d is the grating period. FIG. 5A illustrates an example geometry.

For the in-coupler grating to work properly, according to some examples: (1) for the first order diffraction (m=1), α is in the range [αₘᵢₙ, αₘₐₓ], where αₘᵢₙ is determined by the internal total reflection and Amax is determined by largest grazing angle allowed, for example 75°, and (2) for any other diffraction order second, third, negative first, etc., the diffraction equation may not be satisfied (thus being guided by the waveguide).

The result is summarized in FIG. 5B, where the band 502B corresponds to the field of view supported by a particular grating period d, or its normalized spatial frequency N/d. If asymmetric field of view is targeted, the optimal design may have λ/d≈1.35, labeled in FIG. 5B as V1. On the other hand, if a non-symmetric field of view is targeted, only covering half of the actual field of view, and using a separate grating to cover the other half of the field of view, then the optimal design might have λ/d=1.0 (V3) or λ/d=1.75 (V2 in FIG. 5B). However, in general having a large d may facilitate fabrication and have higher efficiency. Thus, in some embodiments, λ/d=1.1.

FIG. 5A shows the relationship between the incident angle θ and the diffracted angle α. Those of skill in the art will recognize that if the incident ray comes from the left side, then the angle theta will be negative. The target for the in-coupler grating is that the diffraction angle lies between αₘᵢₙ (determined by the internal total reflection) and αₘₐₓ (determined by largest grazing angle, for example, 75°). FIG. 5B shows the incident angle θᵢₙₚᵤₜ as a function of normalized grating spatial frequency λ/d where λ is the wavelength and d is the grating period.

The figure of merit function to maximize is shown in Equation 2.

$${max}_{\{ shape \}} F O M = {min}_{\begin{matrix}θ ∈ \{ {θ}_{1} , {θ}_{2} , {θ}_{3} , {θ}_{4} \} \\ η ∈ \{ {η}_{a} , {η}_{b} , {η}_{c} \}\end{matrix}} power ( θ , η ) \qquad Equation 2$$

In Equation 2, power(θ,η) is the transmission of the first order light, given the incident angle θ and the fabrication condition η, {θ₁, θ₂, θ₃, θ₄} is a set of angles of the incident light. {ηₐ, η_{b}, η_{c}} is a set of parameters describing the fabrication constraint of the manufacturing process. Depending on the exact fabrication process (e.g., e-beam lithography, deep UV lithography, or nanoimprint lithography, etc.), this fabrication constraint might, in some cases, be different.

What Equation 2 represents is that among all the fabrication condition, and all the possible incident angles, the worst-case performance is optimized. Alternatively, Equation 3 can be used

$${max}_{\{ shape \}} FOM = {sum}_{\begin{matrix}θ ∈ \{ {θ}_{1} , {θ}_{2} , {θ}_{3} , {θ}_{4} \} \\ η ∈ \{ {η}_{a} , {η}_{b} , {η}_{c} \}\end{matrix}} A ( θ , η ) \cdot power ( θ , η ) \qquad Equation 3$$

In Equation 3, there is an additional parameter A(θ, n) that describes the relative importance (or weight) of different condition. For example, if A(θ, n)=1, it means that all conditions are weighted equally. Depending on the exact target response, different figure of merit functions can be used.

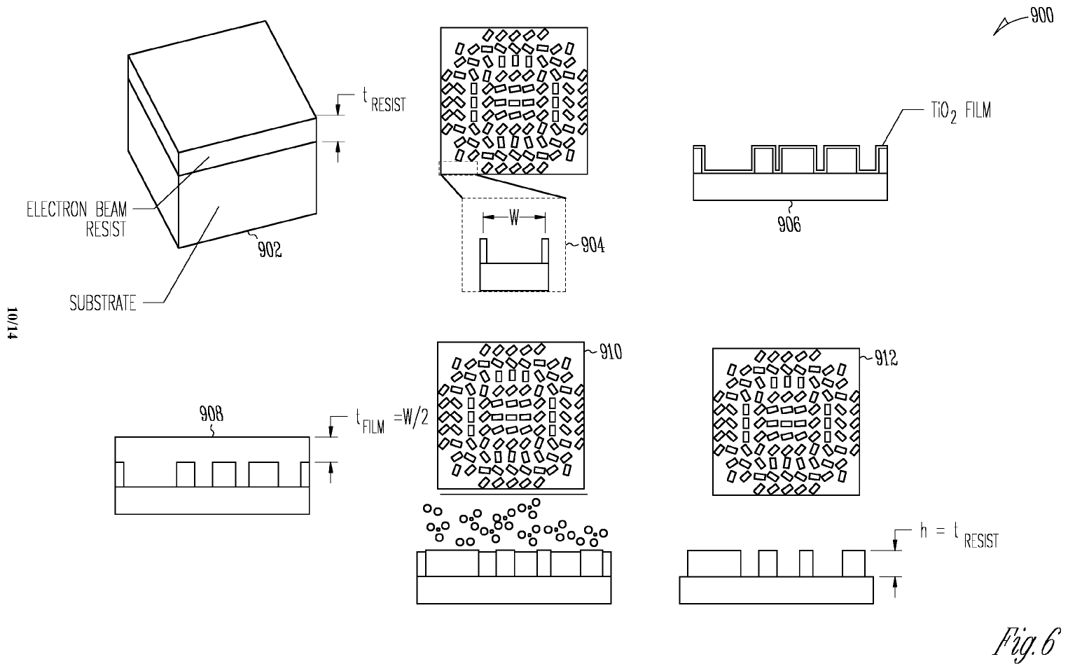

FIG. 6 illustrates an e-beam lithography and atomic layer deposition (ALD) process 900 for nanofabrication of titania nanostructures. At block 902, resist is first spin-coated on glass substrate, followed by e-beam pattern exposure at block 904. Blocks 906 and 908 include TiO₂ ALD deposition. Block 910 shows reactive ion etching (RIE). Block 912 includes removal of the remaining resist.

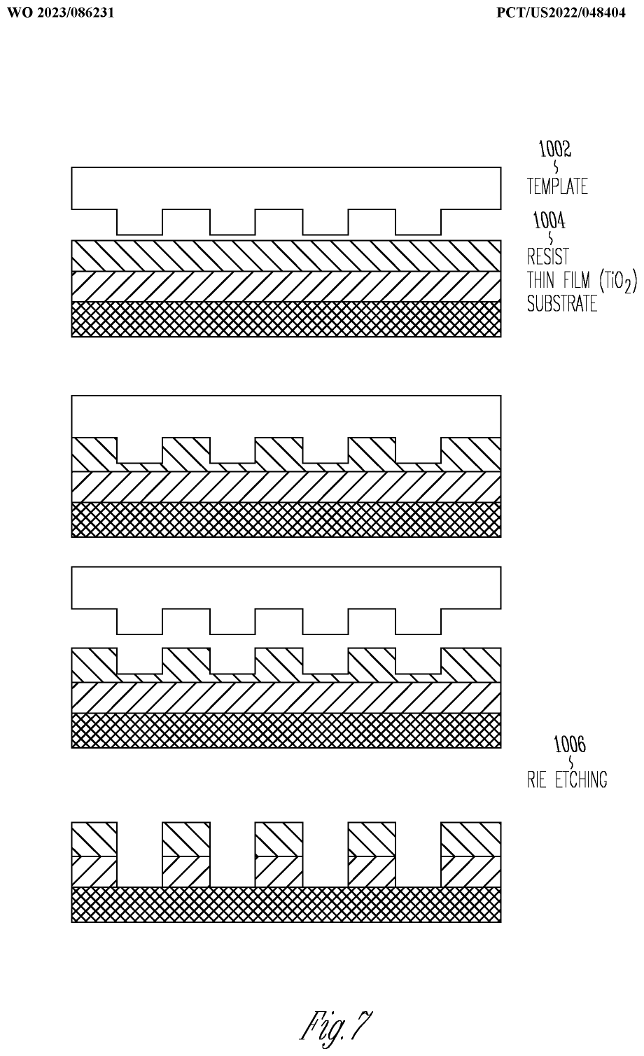

Because the inverse design grating structures can be realized from a single height level of dielectric material, it is possible to fabricate the device using high volume techniques such as nanoimprint (or roll-to-roll nanoimprint) lithography (NIL). A schematic of the NIL process is shown in FIG. 7.

FIG. 7 illustrates an example procedure 1000 for nanoimprint lithography (NIL). A template 1002 is fabricated using e-beam lithography with the negative of the intended pattern. A thin film 1004 of TiO₂ is deposited onto a glass substrate, followed by a thin layer of polymer resist. The template is pressed into the resist, forming the inverse of the intended pattern. The stack is then etched using RIE etching 1006, (e.g., using inductively coupled plasma (ICP) RIE) with the polymer layer providing a hard mask.

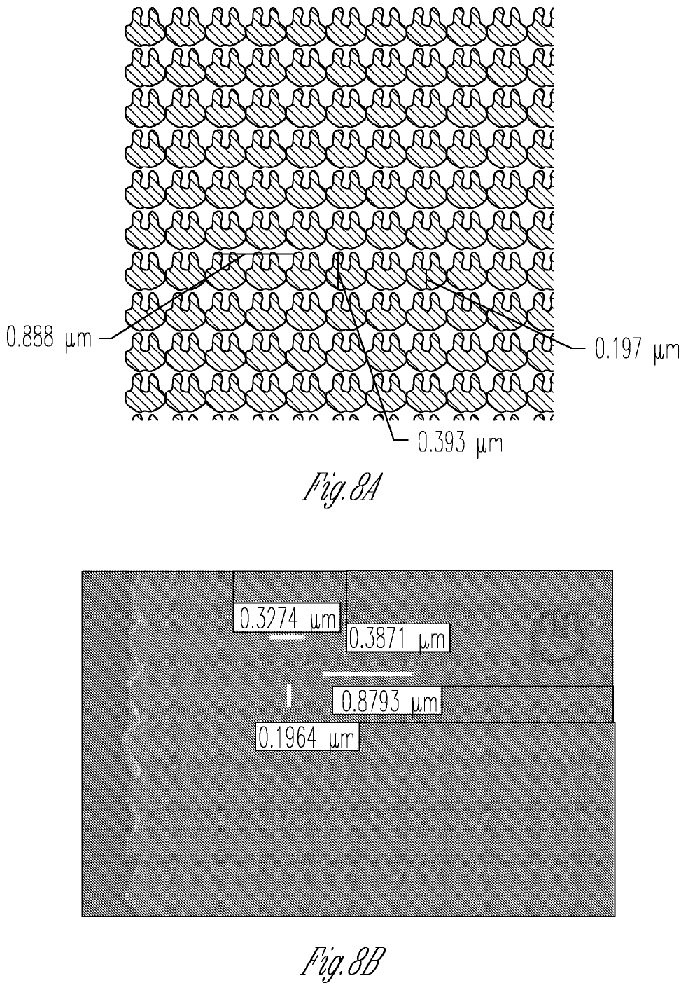

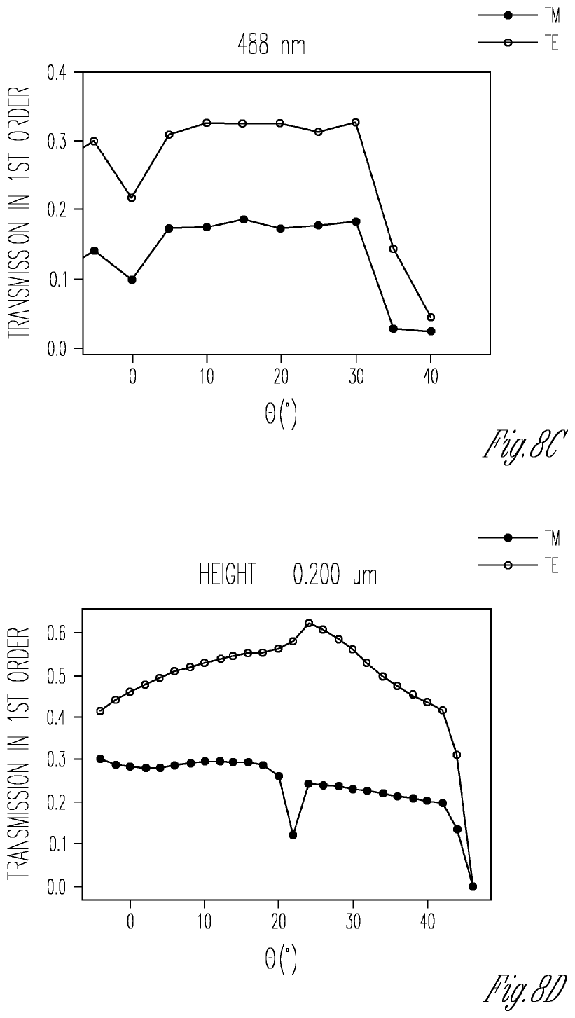

Using the e-beam lithography and ALD deposition process from FIG. 6, some embodiments may fabricate an inverse-design grating coupler as a proof-of-concept. The grating coupler may be designed for 488 nm (unit cell of 444 nm). A top-down view of the structure is shown in FIG. 8A. To allow the beam to transmit through the sample without total internal reflection (TIR), the substrate (n=1.8) may be bonded, for example and among other things, to an N-SF11 prism (n=1.82 at λ=455 nm) using n=1.7 adhesive. In one example, the adhesive may be product number NOA170 (Norland Products). The transmittance of the first order beam is shown in FIG. 8C, correcting for Fresnel losses between the interfaces. The polarization dependence of the grating coupler and angular dependence of the transmittance is in good agreement with the theoretical spectrum. The overall efficiency of the device may, in some cases, be improved with further process refining, for example by removing some of the residual resist in between the grating features seen in FIG. 8B.

FIG. 8A illustrates a top-down view of the structure, in accordance with some embodiments. For example, FIG. 8A may include a pattern target .gds file for inverse design grating. FIG. 8B illustrates example scanning electron microscope (SEM) image of fabricated TiO₂ inverse design grating, in accordance with some embodiments. FIG. 8C illustrates example measured first-order transmittance of the grating device for TE (transverse electric) and TM (transverse magnetic) polarizations, in accordance with some embodiments. Incident angles within the TM region produce first order beams that have deflection angles higher than the TIR angle between the substrate and adhesive. FIG. 8D illustrates example simulated transmittance of the grating device for TE and TM polarizations using Rigorous Coupled-Wave Analysis (RCWA) method, in accordance with some embodiments.

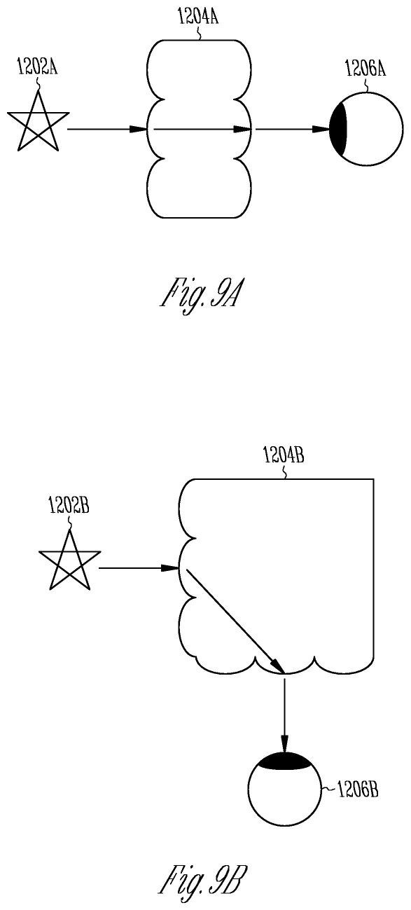

FIGS. 9A-9B illustrate example glass configurations in which some embodiments may be implemented. In FIG. 9A, an object 1202A is viewed through an etched glass 1204A with metasurface waveguide couplers by an eyeball 1206A The light passes directly through the glass 1204A, such that the eyeball 1206A is on the opposite side of the glass 1204A from the object 1202A. In FIG. 8B, an object 1202B is viewed through an etched glass 1204B with metasurface waveguide couplers by an eyeball 1206B. The light passes directly through the glass 1204A, such that the eyeball 1206B is on an adjacent side of the glass 1204B from the object 1202B. In FIG. 8B, light is refracted (e.g., by the metasurface waveguide couplers) to travel to the adjacent side of the glass 1204B rather than to the opposite side of the glass, as in FIG. 8A.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading can occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “substantially no” as used herein refers to less than about 30%, 25%, 20%, 15%, 10%, 5%, 3%, 2%, 1%, 0.5%, 0.1%, 0.05%, 0.001%, or at less than about 0.0005% or less or about 0% or 0%.

Those skilled in the art will appreciate that many modifications to the embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of or illustrative embodiments is provided for the purpose of illustrating the principles of the present disclosure and not in limitation thereof and can include modification thereto and permutations thereof.

Some embodiments are described as numbered examples (Example 1, 2, 3, etc.). These are provided as examples only and do not limit the technology disclosed herein.

1. A grating coupler, the grating coupler comprising:
a substrate comprising a first major surface and a second major surface; and
a surface relief structure located on at least one of the major surfaces of the substrate
wherein:
the grating coupler has a first order diffraction efficiency of at least 0.3 (30%) across at least a 20° incident light angle range.

2. The grating coupler of claim 1, wherein at least one of the periodicity in the x-direction and the periodicity in the y-direction is from about 0.4 μm to about 0.7 μm.

3. The grating coupler of claim 1, wherein the grating coupler has a ratio of first order diffraction efficiency to a refractive index of the surface relief structure of about 0.05 to about 0.15.

4. The grating coupler of claim 1, wherein the grating coupler has a first order diffraction efficiency of at least 0.3 (30%) across at least a 40° incident light angle range.

5. The grating coupler of claim 1, wherein the first order diffraction efficiency does not change by more than 20% from a peak efficiency over at least a 30° incident light angle range.

6. The grating coupler of claim 1, wherein the surface relief structure has an average height in a z-direction of about 0.15 μm to about 0.25 μm.

7. A grating coupler, the grating coupler comprising:
a substrate comprising a first major surface and a second major surface;
a surface relief structure located on at least one of the major surfaces of the substrate the surface relief structure having a periodicity in an x-direction of about 0.2 to about 1 μm and a periodicity in a y-direction of about 0.2 μm to about 1 μm;
wherein:
the surface relief structure comprises a plurality of notches, each of the notches facing substantially in a x-direction and having a radius of curvature greater than about 50 nm.

8. The grating coupler of claim 7, wherein at least one of the periodicity in the x-direction and the periodicity in the y-direction is from about 0.4 μm to about 0.7 μm.

9. The grating coupler of claim 7, wherein the grating coupler has a ratio of first order diffraction efficiency to a refractive index of the surface relief structure of about 0.05 to about 0.15.

10. The grating coupler of claim 1, wherein the surface relief structure has an average height in a z-direction of about 0.15 μm to about 0.25 μm.

11. The grating coupler of claim 7, wherein the surface relief structure comprises a plurality of contiguous columns arranged in the periodicity in the x-direction, the columns extending in the y-direction.

12. The grating coupler of claim 7, wherein the surface relief structure comprises a plurality of non-contiguous columns and rows arranged in the periodicity in the x-direction and the y-direction.

13. The grating coupler of claim 7, wherein the grating coupler has a first order diffraction efficiency of at least 0.3 (30%) across at least a 40° incident light angle range.

14. The grating coupler of claim 7, wherein the first order diffraction efficiency does not change by more than 20% from a peak efficiency over at least a 30° incident light angle range.

15. The grating coupler of claim 1, wherein the surface relief structure has a refractive index of at least 2.1.

16. The grating coupler of claim 1, wherein the substrate is a glass substrate.

17. The grating coupler of claim 1, wherein the surface relief structure comprises an inorganic material or an organic material.

18. The grating coupler of claim 1, wherein the surface relief structure comprises TiO₂.

19. The grating coupler of claim 1, wherein the surface relief structure comprises (poly) methylmethacrylate (PMMA).

20. The grating coupler of claim 1, wherein the grating coupler comprises only two levels comprised of the substrate and the surface relief structure, without any intermediate levels.
